(19) United States
(12) Patent Application Publication
(10) Pub. No.: US 2018/0056586 A1
(43) Pub. Date: Mar. 1, 2018

(54) Tailored Multi-Material Delivery for Direct-Write Manufacturing

(71) Applicant: The Government of the United States of America, as represented by the Secretary of the Navy, Arlington, VA (US)

(72) Inventors: David R. Mott, Burke, VA (US); André A. Adams, Burke, VA (US); Jonathan D. Yuen, Washington, DC (US); Michael A. Daniele, Raleigh, NC (US)

(21) Appl. No.: 15/686,379

(22) Filed: Aug. 25, 2017

Related U.S. Application Data
(60) Provisional application No. 62/380,000, filed on Aug. 26, 2016.

(51) Int. Cl. B29C 64/209; C08G 61/12; B29C 64/112; B33Y 10/00; B33Y 30/00; B33Y 70/00

(52) U.S. Cl. CPC B29C 64/209; C08G 61/126; B29C 64/112; B29K 2071/02; B33Y 30/00; B33Y 70/00; B33Y 10/00

(57) ABSTRACT

A method of direct-write manufacturing (3D printing) includes a simple to manufacture printhead configured to create sheathed flow. The method is operable at room temperature and suitable for use with sensitive materials.

### CROSS-REFERENCE TO RELATED APPLICATIONS

This Application claims the benefit of U.S. Provisional Application 62/380,000 filed on Aug. 26, 2016, the entirety of which is incorporated herein by reference.

This Application is also related to U.S. Pat. No. 8,361,413 issued on Jan. 29, 2013 and those patents and applications which directly or indirectly claim priority from it.

### BACKGROUND

Direct-write additive manufacturing processes (generally known as “3-D printing”) can create three-dimensional objects as directed by a computerized source. This has the potential to simplify the logistics of complex machinery and equipment deployed far from their point of manufacture or static maintenance facilities. Instead of transporting and stockpiling replacement parts for such systems, some components can be produced as needed either at the point of use or some forward support location. More profoundly, emerging additive manufacturing processes have the potential to generate new capabilities and enhance existing ones by combining novel materials and structures that are impossible or prohibitively expensive to pursue with traditional manufacturing approaches.

Typically, a 3-D printed object is constructed via layer-by-layer deposition from a printhead specially designed to emit certain materials, based on a sectional digital model of the object. Various additive manufacturing processes have been created to build objects in plastic, metal, ceramic and/or biological materials.

Existing technologies do have limitations. First, in the printing process, the material (either as a liquid, a slurry, or within a liquid solvent) is delivered through a nozzle, continuously or as a series of drops. Due to the pressure required to drive the deposition through process channels and the output nozzle, the range of materials that can be used for writing is limited by material properties, most critically, viscosity. Second, pressure limitations also constrain how small the delivery nozzle can be, which in turn limits the resolution of the printed output. Third, as materials are often melted under high temperature for the deposition process and then solidified after hitting the substrate or material deposited previously, delicate materials or materials with certain chemical or bio-active properties are not compatible with the process. Hence, while printed hybrid embedded electronics and 3D printed circuits show promise in advancing many technologies, providing the electrical interconnects between printed components and devices remains a challenge with the above-mentioned limitation.

The use of microfluidic techniques to expand both the range of materials and printing flexibility is a recent innovation. An example of a microfluidic printhead is described by Jennifer Lewis et al. in a 2015 paper (Advanced Materials, 27 3279-3284) and US patent application publication no. 2014/0314954, both incorporated herein by reference for the purposes of disclosing devices and methods for direct write manufacturing. The printhead describes is a multi-nozzle deposition system for direct write applications and includes a body embedded with a first network of microchannels which branches from a parent microchannel(s) through a series of daughter channels. The multiplicity of channels allows mixtures of inks of different materials to be printed simultaneously over an extended length, as determined by the number of output channels. Nonetheless, this does not address the issue of limited materials range. Inks must be rigorously designed to enable them to pass through the various process channels, but a prerequisite is miscibility of the subcomponents.

One approach to expand the materials range of 3D printing is to encase or clad a core material fluid in a surrounding secondary, generic fluid via the microfluidic process of sheath flow. Hydrodynamic focusing is the steering of a fluid (core) with a secondary boundary fluid (sheath), where under the proper conditions, the impinging fluids do not mix while the momentum and inertia of the sheath fluid shape the core. At the microscale, hydrodynamic focusing generates a large ratio of surface area to volume and creates an interface between fluids that can be precisely controlled. Unlike the traditional planar interface generated by 2D hydrodynamic focusing, fluids focused in 3D are shaped in multiple directions. To provide the proper conditions for 3D hydrodynamic focusing, miscible fluids have to remain separated over extended lengths within a microfluidic channel during which, under laminar flow conditions, their diffusive interface can be controlled and used in sample manipulation. Phase separation is a technique which involves multiple fluid interfaces between two (or more) miscible fluids brought in contact, effectively separating them and allowing the fluids to flow as parallel streams. The United States Navy has developed such techniques as disclosed in U.S. Pat. Nos. 8,361,413, 8,398,935, and 9,573,311, each of which is incorporated herein by reference for the purposes of disclosing devices and methods for sheath flow.

Microfluidic printheads that rely on 3D hydrodynamic focusing are described in US patent application publication nos. 2014/0035975 and 2016/0136895. In US2014/0035975, the sheathed core fluid is formed by doubly nested nozzles, where the inner nozzle ejects the core fluid and the outer nozzle the sheath fluid. Such nozzles tend to require costly precise manufacturing. The sheath fluid is specifically described as and is chosen to be a sacrificial material with a very specific boiling temperature that is “10 to 40 degrees” below that of the core material. In the envisioned usage, the stream is heated upon its exit from the nozzle such that the sheath material vaporizes and the core is delivered to the build substrate alone. The printhead in US2016/0136895 relies on multiple inlets that pump fluids into the path of the main channel, forming the sheath flow along the main channel. US2016/0136895 consistently describes the core material as a hydrogel. The spatial manipulation of the printheads to form a 3D printing system is less extensively described in these previous works, but in both the Lewis paper and US2016/0136895, the embodiment involves the printheads and/or the sample stage to be controlled by mechanical manipulators.

Each of the previously described embodiments includes shortcomings and limitations that the current invention transcends. For US2014/0035975, the limitations include the fact that careful and precise alignment of the outer and inner nozzles is required to ensure accurate sheath flow; and that the delivery of the core fluid is limited by the inner nozzle diameter, which is inflexibly constrained by construction limitations. As mentioned above, the sheath fluid is limited to a sacrificial material with a required specific range of boiling temperature. US2016/0136895 consistently describes the core material as a hydrogel, and it does describe alternating the core material via valving as well as forming a coaxial hydrogel fiber using an inner core and outer shell of different hydrogels.

It is not believed that the above-described approaches include the capability to reshape and reposition the core within the sheath stream. The technique described herein enables the use of complex combinations of a wide variety of materials to form a variety of structures.

### BRIEF SUMMARY

Described herein is a discrete multi-material deposition system in which the molding process utilizes microfluidically derived sheath flow created with customized geometric features to manipulate multiple fluid flows creating core fluids of different sizes and shapes, encapsulated within the sheath fluid. This sheath stream acts as a “dynamic virtual nozzle” that can be used to reshape and focus the core stream to sizes ranging from 300 nm to 0.5 mm, significantly below the physical dimensions of the solid nozzle. Not only does this deposition system offer improved printing flexibility and enhance printing resolution, its unique ability to create sheath encapsulated core streams without complex architectures helps expand the range of materials that can be used for direct writing, including materials with higher viscosity, delicate materials, as well as materials with chemical or bio-active properties that are not compatible with current approaches.

In one embodiment, a method of manufacturing includes providing a printhead comprising two opposing plates each having a pattern of grooves and ridges configured to create sheathed flow output from separate sheath and core fluid inputs; pumping sheath and core fluid through the printhead thereby causing a sheathed flow comprising the core fluid surrounded by the sheath fluid to be deposited onto a printbed; and causing the printhead and the printbed to move in relation to one another in order to controllably manufacture a structure from the sheathed flow, wherein, after being deposited, the core fluid sinks past the sheath fluid and onto the substrate while the sheath fluid remains in a fluid state, followed by polymerization of the core fluid.

In another embodiment, a method of manufacturing includes providing a printhead comprising two opposing plates each having a pattern of grooves and ridges configured to create sheathed flow output from separate sheath and core fluid inputs; pumping sheath and core fluid through the printhead thereby causing a sheathed flow comprising the core fluid surrounded by the sheath fluid to be deposited onto a printbed; and causing the printhead and the printbed to move in relation to one another in order to controllably manufacture a structure from the sheathed flow, wherein, after being deposited, the core fluid remains suspended in the sheath fluid away from the substrate.

### BRIEF DESCRIPTION OF THE DRAWINGS

FIG. 1A is a schematic of the sheath flow printhead and the mechanism in which the sheath flow is formed, showing a computer model of a sheath flow chamber (suitable for a printhead) with the inlets showing two separate flows at the top right, and the outlet showing the sheathed flow at the bottom left. FIG. 1B shows a simulation of the two parallel flows prior to geometric perturbation, and the sheath flow after being subjected to perturbations. FIG. 1C shows a cross-section of an actual experimental result using a device based on the model of FIG. 1A. The image in FIG. 1D is an example of nanometer sized ribbon formed within the core of the sheath flow.

FIG. 2 shows simulated and experimental results of the sheath flow subjected to different combinations of geometric perturbations. Close correlation between simulation and experiment is observed.

FIG. 3 is a schematic showing individual components of the printhead stacked in sequence prior to assembly.

FIG. 4 is a schematic of the printing system assembly consisting of the printhead, the print fluid dispensing system and the 3D stage for positioning of the substrate.

FIGS. 5A-5E illustrate the method in which a single line consisting of a two-component sheath flow is printed (FIG. 5A), and possible structures that can result. By positioning the core near the edge of the extruded line that is applied to the substrate, and delaying or preventing solidification of the sheath fluid, the core is delivered to the substrate (FIGS. 5B and 5C). By positioning the core in the line farther from the substrate and delivering the stream when both core and sheath are more rigid, the core will remain suspended above the substrate (FIGS. 5D and 5E).

FIG. 6 is a schematic of a bioelectronic transistor printed using a layer-by-layer approach with the sheath flow printing method.

### DETAILED DESCRIPTION

### Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of ±10% of that stated.

As used herein, the term “sheath flow” refers to the surrounding of a central flow stream (the core) with a sheath stream. Sheath flow is normally laminar flow that substantially avoids mixing between the core stream and the sheath stream.

Description and Operation

Described herein is a sheath flow printing system using of a microfluidic printhead which involves the injection of materials of different types into various inlet channels of the printhead, whereupon these materials are discharged into mixing channels, where they converge. The converged flows are molded into desired sheathed flow patterns, and the sheath flow is extruded onto a substrate under digital direction of a mechanical controller. This printing system differs from the previous systems described above in terms of the process whereby the sheath flow is formed. For the previous descriptions, the sheath flow is completely formed at the onset of entry of all the flows into the mixing channel. In contrast, the converged flows in the present device are molded as they transverse the mixing channel(s). This molding is achieved via the presence of geometric features that decorate the surface of the channel.

Sheath flow can be achieved with the placement of geometric features or the use of varying topology within the mixing channel that generates unique fluid interfaces across both the lateral (in the plane of the flow) and vertical directions. In particular, within the Stokes regime, while a change in the flow rate alters the pressure distribution along the channel and the magnitude of the velocity, it does not affect the paths of the streamlines: in the absence of inertial effects, the velocity fields at different net flow rates differ by a scalar multiple. As a consequence, geometric features such as grooves that rearrange the fluid distribution within the channel cross section (such as creating and shaping a sheath flow) will produce the same result regardless of varying flow rates and fluid properties (viscosity and density) provided that the Reynolds number (Re) stays sufficiently low.

A suitable printhead can be made as described in U.S. Pat. No. 9,573,351 and can include a channel having a proximal end and a distal end, said channel having at top surface and a bottom surface; at least one first input in direct connection with said channel for introducing a sheath stream at said proximal end; at least one second input in direct connection with said channel for introducing a core stream at said proximal end; at least one first fluid transporting structure across said channel located on said top surface; at least one second fluid transporting structure across said channel located on said bottom surface, said first and second fluid transporting structures being located between said proximal and said distal end and on opposing surfaces facing one another across the channel, wherein said first and said second fluid transporting structures are configured to transport said sheath stream across said channel to surround said core stream thereby creating sheath flow; and an output at said distal end of said channel. The fluid transporting structures can be grooves and/or ridges.

In embodiments, the printhead can consist of a pattern of grooves and/or ridges (the fluid transporting structures) formed in or on two opposing plates, without need for other features in order to create the sheathed flow from the input streams. The printhead can be made of sufficiently rigid and strong materials such as metals, plastics, and/or ceramics using suitable techniques. For example, the printhead can be made by one or more methods including machining, 3D printing, lithography, injection molding, and casting.

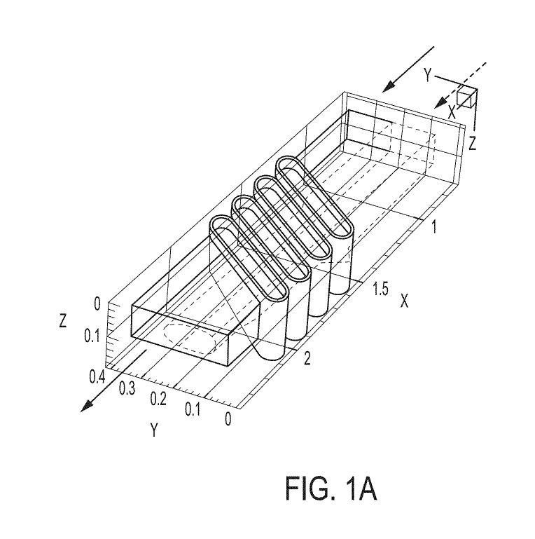

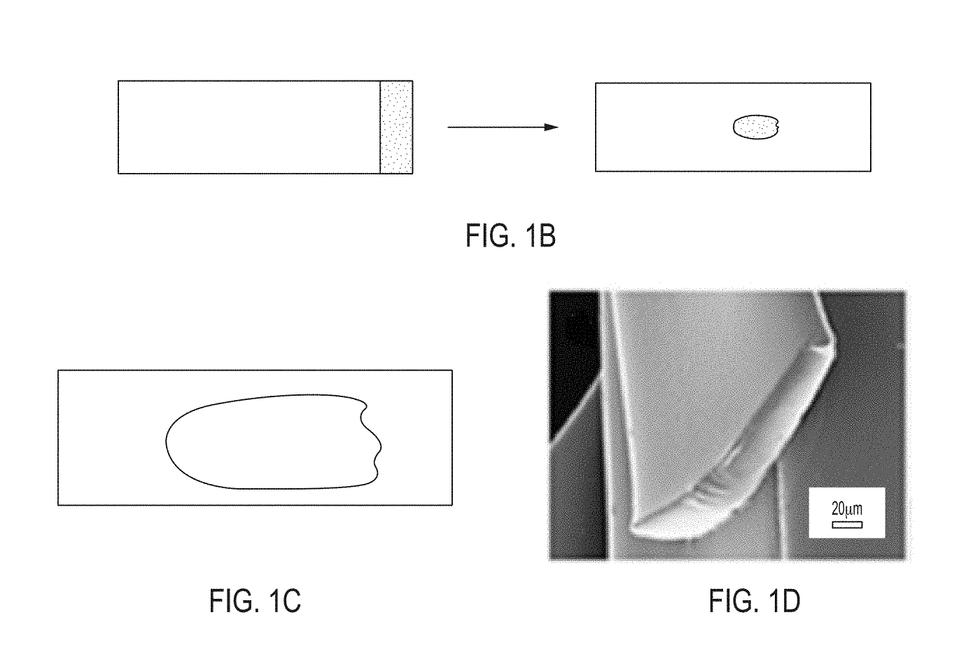

FIGS. 1A-1D shows a various images (both model and experimental data) relating to the formation of a sheath flow in the presence of Chevron-shaped grooves along the mixing channel, where two parallel flows subsequently under perturbative interference eventually merge to form a sheath flow. Additionally, computational simulation can be used to explore more elaborate rearrangements of the parallel flows, resulting in complex fluid patterning. FIG. 1A is a schematic of the sheath flow printhead and the mechanism in which the sheath flow is formed, showing a computer model of a sheath flow chamber (suitable for a printhead) with the inlets showing two separate flows at the top right, and the outlet showing the sheathed flow at the bottom left. FIG. 1B shows a simulation of the two parallel flows prior to geometric perturbation, and the sheath flow after being subjected to perturbations. FIG. 1C shows a cross-section of an actual experimental result using a device based on the model of FIG. 1A. The image in FIG. 1D is an example of nanometer sized ribbon formed within the core of the sheath flow.

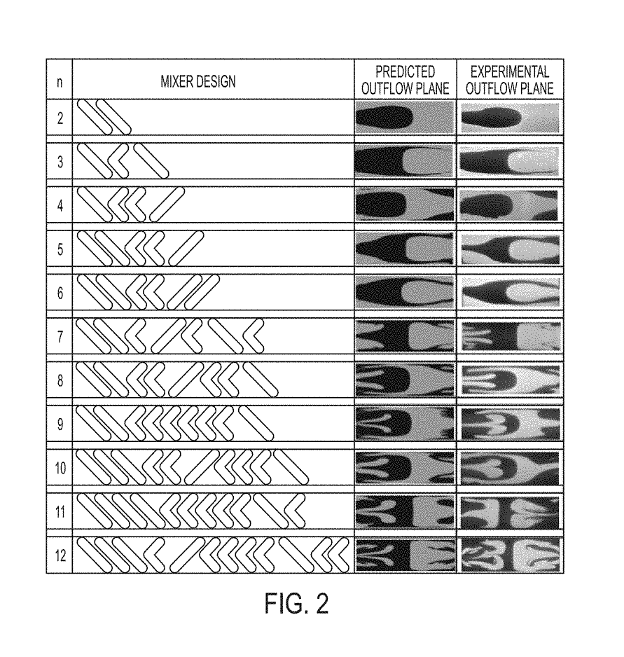

FIG. 2 shows results of computational simulations and the corresponding experimental have experimentally verified as shown in FIG. 2. This method of sheath flow pattern formation benefits from a behavior of Stokes regime: that components operating in the Stokes regime are insensitive to modest changes in flow rate and fluid properties. Although the theoretical requirement for Stokes flow is Re<<1 (White, 1991), authors have reported Stokes-flow behavior at Re=10 for channel flow (Howell et al., 2005 and Mott et al., 2006). In practice, the Reynolds of flow should be less than 20.

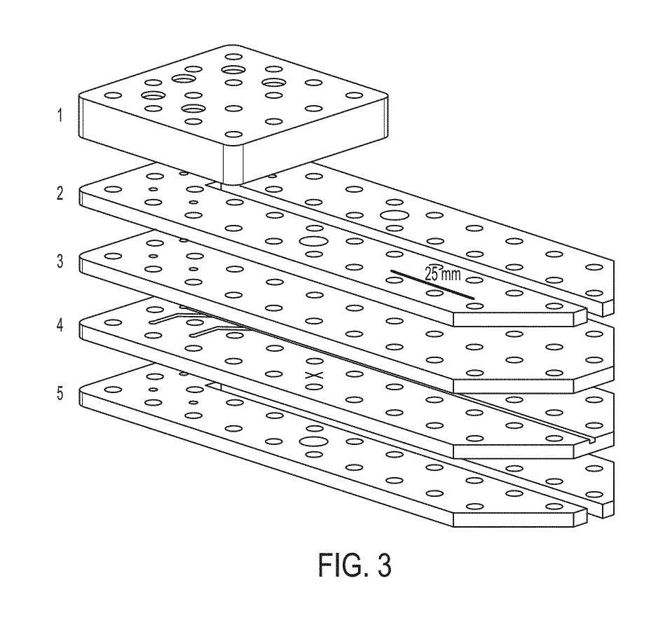

In various embodiments, the sheath flow printhead includes of planar layers of different materials, machined to the desired forms and attached together (for example, using bolts) to form an air-tight structure, the presence of inlets and outlets excepting. A combination of direct micromilling, hot-embossing, and/or polymer casting can be used to create these components. One exemplary sheath flow printhead consists of five separate layers, which are depicted in FIG. 3. Described herein is: 1. An inlet chuck (machined from aluminum), 2. a top fastening plate (machined from aluminum), 3. a microchannel top layer (formed by hot embossing or polymer casting of cyclic olefin copolymer (COC) or polydimethylsiloxane (PDMS)), 4. a microchannel bottom layer (formed by hot embossing or polymer casting of COC or polyether ether ketone (PEEK)), and 5. a bottom fastening plate (machined from aluminum). The materials used for various components do not need to be the same as in this example, and can be varied as recognized in the art.

An exemplary sheath flow device can be assembled from the bottom up by placing the bottom fastening plate at the bottom, then the microchannel bottom layer, followed by the microchannel top layer, followed by the remaining fastening plate, and finally, the inlet chuck. The machining of bolt holes on all layers ensures that the shaping grooves align with each other along the edges of the channel and that the fluid shaping geometries in the COC layers perfectly overlap when bolts are inserted to clamp the layers together. A dissection microscope can be used to aid in the alignment. Bolts are inserted across the center of the device, and hand tightened with nuts to clamp the device together. Standard HPLC fittings are then attached to the inlets to interface the sheath flow device to tubing and syringes that contain sheath fluid and core material fluids.

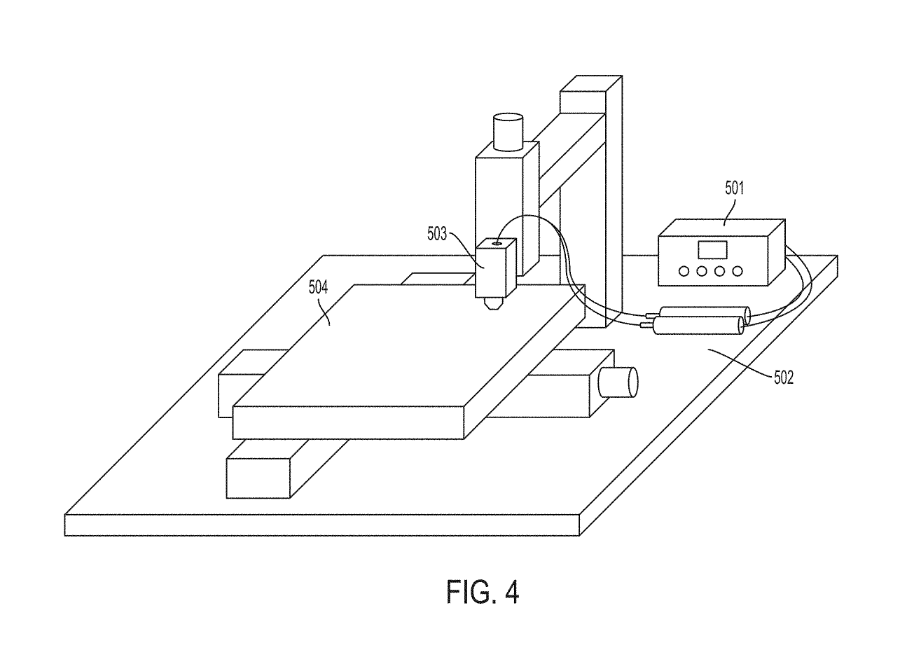

The printhead integrates into a printing system which can enable 3D printing processing. As shown in FIG. 4, the system comprises the microfluidic printhead 503, material reservoirs 502 for storing the materials to be used for printing, dispensing systems which transfer material from the reservoirs to inlets on the printhead via coupling tubes, and 3D motorized controllers to situate the outlets of the printhead at locations where the materials are to be ejected. For the dispensing unit, a pressure control unit will provide pressurized force to create fluid flow from the material reservoirs to the inlets of the microfluidic printhead via coupling tubes. In this case, a series of electronically controlled syringe pumps could be used to provide the necessary force for dispensing each material into a printhead entry orifice. Alternative means for dispensing the material can also be utilized beyond what is illustrated in this embodiment. For example, pumping of the fluids can be accomplished via electrowetting, magnetic propulsion (for magnetic materials), pneumatic pressure and/or gravitational flow.

As shown in FIG. 4, the microfluidic printhead can be affixed to a fixed holder which places the printhead in a stationary position above a printbed seated on a 3D motorized stage. The 3D motorized stage arms are driven by three corresponding motors and are controlled by a programmable control processor, such as a computer. In embodiments, a controller 501 (optionally part of the programmable control processor) directs output from the sheath and core fluid reservoirs 502, which can be, for example, syringe pumps, through tubing before flowing through the printhead 503. In the illustrated embodiment, the printbed 504 moves along all three primary axes of a Cartesian coordinate system, propelled by the motion of a 3D motorized stage, as defined by computer software. Beyond what is shown in FIG. 4, instead of a fixed holder for the printhead, a positioning unit can be used instead to move the printhead to the desired coordinates for material dispensing. The positioning can also be driven by three corresponding motors and controlled by a programmable control processor. In some instances it may be desirable to combine both embodiments in a single apparatus with movable printhead and bed. Additionally, alternative means for positioning the printhead can be utilized beyond what is illustrated for this system, for example as piezoelectric, magnetic and/or electrostatic positioners.

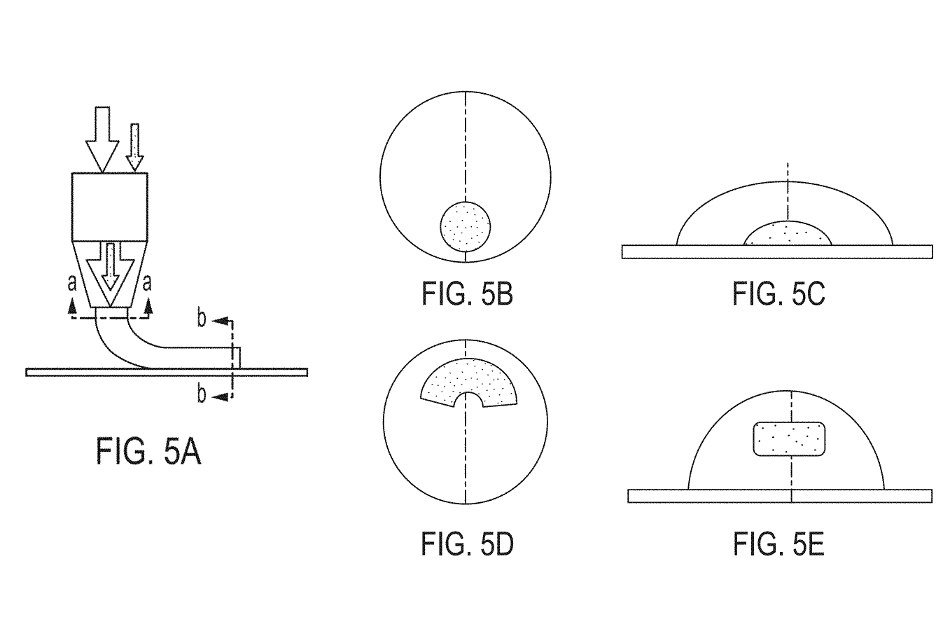

Freestanding lines can be printed using this print system, forming various types of line-based structures. As shown in FIG. 5A, the printing system typically has the printhead placed at a certain distance from the substrate to prevent the printhead from scratching or being scratched by the substrate. As the sheath fluid is being extruded, the printhead moves at a velocity commensurate with the extrusion rate. The line is completed when the printhead is directed to stop extrusion.

FIGS. 5B-5E illustrate two examples of the type of lines than can be printed by the system. For Case 1 (FIGS. 5B and 5C), printing is made under conditions and using materials such that the inner core fluid sinks through the outer sheathing fluid and makes contact with the substrate. The outer sheathing fluid either solidifies or evaporates. By tailoring the materials (selecting for properties such as density and volatility) and deposition conditions, solidification of the sheath fluid is delayed relative to solidification of the core fluid, enabling delivery of the core stream directly to the substrate, and optionally the sheath fluid does not solidify at all. In Case 1 the sheath fluid can be part of the final component or it could be sacrificial and be absent therefrom. A sacrificial sheath could be washed away or evaporate after it is used to shape, position, and deliver the core to the substrate. Case 1 could be useful for the deposition of sensitive or reactive materials, such as biological substances or liquid metals, which require a protective covering during the printing process. For Case 2 (FIGS. 5D and 5E), both outer fluid and core fluid are relatively rigid, and core remains in the same position as it was deposited. Applications for Case 2 include freestanding interconnects and capacitive devices.

The printing process for individual layers is similar to that used for individual lines, with the exception that the lines are so closely spaced that they merge forming a two dimensional sheet. Material is dispensed from the printhead as the positioning unit is moved in a pattern controlled by software, thereby creating a first layer of the dispensed material on the receiving surface. Additional layers of dispensed material are stacked on top of one another such that the final 3D geometry of the dispensed layers of material is generally a replica of the 3D geometry as designed by the software. The 3D design may be created using typical 3D CAD (computer aided design) software or generated from digital images, as known in the art. Further, if the software generated geometry contains information on specific materials to be used, it is possible, according to one embodiment of the invention, to assign a specific material type to different geometrical locations.

The core fluid can contain a polymerizable material, for example gelatin methacrylamide, polyethylene glycol, poly(3,4-ethylenedioxythiophene) (PEDOT). In embodiments the core and/or sheath can also include suspensions of particles (such as nanoparticles and/or living cells) optionally together with a polymerizable material. Materials used in this technique can include those which can be dissolved to form aqueous or organic solutions, or are in liquid form themselves, however preferred embodiments use fluids and corresponding flow rates that have Reynolds number below 20.

In embodiments, the sheath fluid contains a polymerizable material, either the same or different from a polymerizable material in the core, or optionally the core has no polymerizable material.

Polymerizable materials can be polymerized after deposition using conventional techniques such as exposure to ultraviolet light.

Because this process is operable at room temperature or cooler (rather than the elevated temperatures required for conventional 3D printing), it is suitable for use with bioactive and other delicate materials. However, if desired, this technique can also be practiced at an elevated temperature.

### Examples

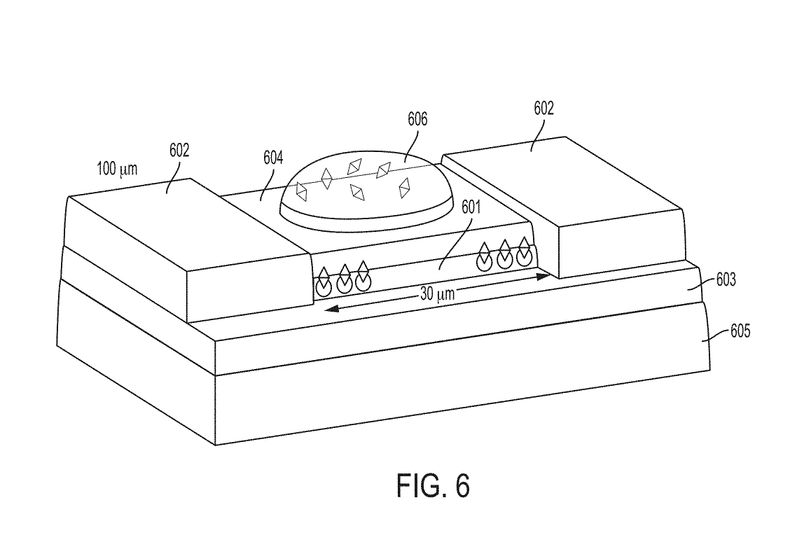

As an example of 3D printing using 3D hydrodynamic focusing to sheath and pattern sensitive materials, a bioelectronic transistor fabricated utilizing layer-by-layer printing is shown in FIG. 6. Due to the biological and chemical sensitivity of streptavidin, it is very difficult to deposit this material by existing printing methods. In this example, an aqueous streptavidin solution is encased in a protective sheath of ethanol and printed as a thin layer 601 on a conductive silicon substrate 605 passivated with a 200 nm layer of silicon oxide 603. Subsequently, layer by layer printing is again used to print a second layer of poly-hexylthiophene (P3HT) 604 over the streptavidin layer. The second P3HT layer serves as a passivation layer as well as the active semiconducting layer. For source-drain contacts, final layers of silver ink 602 are layer-by-layer printed over the P3HT, with the silicon substrate 605 serving as the gate. In the presence of a solution of biotin, shown as a droplet 606 in FIG. 6, the streptavidin modifies the electronic behavior of the P3HT, resulting in a change in transistor properties. Thus, this printing technique produced a transistor which can detect biotin.

Advantages and New Features

Hydrodynamic focusing using perturbative flow can reduce the size of the core fluid to diameters in the hundreds of nanometers within a channel of millimeters. Since specialized constructs are typically required for such narrow fluid diameters, this represents cost-cutting benefits.

Sheath fluid acts as a virtual nozzle, such that the physical nozzle size does not limit the size of the delivered core and can facilitate the delivery of materials that would otherwise clog a physical nozzle.

Materials can be layered in engineered arrangements can enable direct “one pass” printing of a variety of components in complex configurations that require multiple passes and multiple nozzles for standard additive manufacturing processes (hence increasing complexity and undermining resolution).

### CONCLUDING REMARKS

All documents mentioned herein are hereby incorporated by reference for the purpose of disclosing and describing the particular materials and methodologies for which the document was cited.

Although the present invention has been described in connection with preferred embodiments thereof, it will be appreciated by those skilled in the art that additions, deletions, modifications, and substitutions not specifically described may be made without departing from the spirit and scope of the invention. Terminology used herein should not be construed as being “means-plus-function” language unless the term “means” is expressly used in association therewith.

What is claimed is:

1. A method of manufacturing comprising:
providing a printhead comprising two opposing plates each having a pattern of grooves and ridges configured to create sheathed flow output from separate sheath and core fluid inputs;
pumping sheath and core fluid through the printhead thereby causing a sheathed flow comprising the core fluid surrounded by the sheath fluid to be deposited onto a printbed; and
causing the printhead and the printbed to move in relation to one another in order to controllably manufacture a structure from the sheathed flow,
wherein, after being deposited, the core fluid sinks past the sheath fluid and onto the substrate while the sheath fluid remains in a fluid state, followed by polymerization of the core fluid.

2. The method of claim 1, wherein said printhead further comprises top and bottom fastening plates and an inlet chuck in a stacked arrangement with said opposing plates.

3. The method of claim 1, wherein the core fluid comprises a polymerizable material selected from the group consisting of gelatin methacrylamide, polyethylene glycol, and poly(3,4-ethylenedioxythiophene) (PEDOT); and
wherein the polymerizable material is polymerized after being deposited.

4. The method of claim 1, conducted without heating said sheath or core fluids above room temperature.

5. A method of manufacturing comprising:
providing a printhead comprising two opposing plates each having a pattern of grooves and ridges configured to create sheathed flow output from separate sheath and core fluid inputs;
pumping sheath and core fluid through the printhead thereby causing a sheathed flow comprising the core fluid surrounded by the sheath fluid to be deposited onto a printbed; and
causing the printhead and the printbed to move in relation to one another in order to controllably manufacture a structure from the sheathed flow,
wherein, after being deposited, the core fluid remains suspended in the sheath fluid away from the substrate.

6. The method of claim 5, wherein said printhead further comprises top and bottom fastening plates and an inlet chuck in a stacked arrangement with said opposing plates.

7. The method of claim 5, wherein the core fluid comprises a polymerizable material selected from the group consisting of gelatin methacrylamide, polyethylene glycol, and poly(3,4-ethylenedioxythiophene) (PEDOT)); and
wherein the polymerizable material is polymerized after being deposited.

8. The method of claim 5, conducted without heating said sheath or core fluids above room temperature.
